(19) United States
(12) Patent Application Publication
(10) Pub. No.: US 2025/0058232 A1
(43) Pub. Date: Feb. 20, 2025

(54) ITEM PLACEMENT

(71) Applicant: Tencent Technology (Shenzhen) Company Limited, Shenzhen (CN)

(72) Inventors: Yanan ZHANG, Shenzhen (CN); Ye KUANG, Shenzhen (CN)

(73) Assignee: Tencent Technology (Shenzhen) Company Limited, Shenzhen, GD (CN)

(21) Appl. No.: 18/939,501

(22) Filed: Nov. 6, 2024

Related U.S. Application Data
(63) Continuation of application No. PCT/CN2023/123210, filed on Oct. 7, 2023.

(30) Foreign Application Priority Data
Nov. 15, 2022 (CN) 202211430656.8

(51) Int. Cl. A63F 13/69; A63F 13/5372; A63F 13/79; A63F 13/822; A63F 13/92

(52) U.S. Cl. CPC A63F 13/69; A63F 13/5372; A63F 13/79; A63F 13/822; A63F 13/92

(57) ABSTRACT

In a method for item placement in a virtual battle, an item placement preview of the virtual battle is displayed before the virtual battle starts. The item placement preview is configured to provide a preview of a target round of a plurality of battle rounds in the virtual battle and a virtual item to be placed in the target round. A virtual scene of the virtual battle is displayed when the virtual battle starts. The virtual item of the target round is added to the displayed virtual scene during the virtual battle when the virtual battle proceeds to the target round. Apparatus and non-transitory computer-readable storage medium counterpart embodiments are also contemplated.

### RELATED APPLICATIONS

The present application is a continuation of International Application No. PCT/CN2023/123210, filed on Oct. 7, 2023, which claims priority to Chinese Patent Application No. 202211430656.8, filed on Nov. 15, 2022. The entire disclosures of the prior applications are incorporated herein by reference.

### FIELD OF THE TECHNOLOGY

Embodiments of this disclosure relate to the field of computer technologies, including to an item placement method and apparatus, a computer device, and a storage medium.

### BACKGROUND OF THE DISCLOSURE

As computer technologies develop, games are increasingly popular among users. A user may control a virtual object to interact with other virtual objects in a virtual battle. To make games more amusing, virtual items are placed in a virtual battle, so that the user can interact with other virtual objects by using the virtual items.

### SUMMARY

Embodiments of this disclosure provide an item placement method and apparatus, a computer device, and a storage medium. Examples of technical solutions are as follows:

According to an aspect, a method for item placement in a virtual battle is provided. In the method, an item placement preview of the virtual battle is displayed before the virtual battle starts. The item placement preview is configured to provide a preview of a target round of a plurality of battle rounds in the virtual battle and a virtual item to be placed in the target round. A virtual scene of the virtual battle is displayed when the virtual battle starts. The virtual item of the target round is added to the displayed virtual scene during the virtual battle when the virtual battle proceeds to the target round.

According to another aspect, an item placement method is provided. In the method, before the virtual battle starts, an item placement policy for the virtual battle is determined from a plurality of item placement policies, the virtual battle including a plurality of battle rounds. An item placement preview of the virtual battle is generated based on the determined item placement policy. The item placement preview is configured to provide a preview of a target round of the plurality of battle rounds in the virtual battle and a virtual item to be placed in the target round. The item placement preview is provided to a plurality of terminals that is associated with a plurality of players of the virtual battle. The item placement preview is displayed by the plurality of terminals before the virtual battle starts. The virtual item indicated by the item placement preview is added in a virtual scene of the virtual battle during the virtual battle.

According to another aspect, an information processing apparatus, such as an item placement apparatus, is provided. The apparatus includes processing circuitry that is configured to display an item placement preview of a virtual battle before the virtual battle starts. The item placement preview is configured to provide a preview of a target round of a plurality of battle rounds in the virtual battle and a virtual item to be placed in the target round. The processing circuitry is configured to display a virtual scene of the virtual battle when the virtual battle starts. The processing circuitry is configured to add the virtual item of the target round to the displayed virtual scene during the virtual battle when the virtual battle proceeds to the target round.

According to another aspect, an information processing apparatus, such as an item placement apparatus is provided. The apparatus includes processing circuitry that is configured to determining, before the virtual battle starts, an item placement policy for the virtual battle from a plurality of item placement policies, the virtual battle including a plurality of battle rounds. The processing circuitry is configured to generate an item placement preview of the virtual battle based on the determined item placement policy. The item placement preview is configured to provide a preview of a target round of the plurality of battle rounds in the virtual battle and a virtual item to be placed in the target round. The processing circuitry is configured to provide the item placement preview to a plurality of terminals that is associated with a plurality of players of the virtual battle. The item placement preview is displayed by the plurality of terminals before the virtual battle starts. The processing circuitry is configured to add the virtual item indicated by the item placement preview in a virtual scene of the virtual battle during the virtual battle.

According to another aspect, a computer device is provided. The computer device includes a processor and a memory, the memory having at least one computer program stored therein, the at least one computer program being loaded and executed by the processor, to implement the operations of the item placement method in the above aspects.

According to another aspect, a non-transitory computer-readable storage medium is provided. The non-transitory computer-readable storage medium stores instructions which when executed by a processor cause the processor to implement any of the item placement methods in the above aspects.

According to still another aspect, a computer program product is provided. The computer program product includes a computer program, the computer program, when executed by a processor, implementing the operations of the item placement method in the above aspects.

In solutions provided in the embodiments of this disclosure, before the virtual battle starts, the preview of the target round of the virtual battle and the virtual item to be placed in the target round is provided, and in a case that the virtual battle proceeds to the target round, the virtual item of the target round is placed, so that a user can learn information about virtual item placement in the virtual battle in advance. In this way, the user can make a strategical layout on the virtual battle based on the information about the virtual item placement, which improves control of the virtual battle by the user, thereby improving user experience.

### BRIEF DESCRIPTION OF THE DRAWINGS

FIG. 1 is a schematic structural diagram of an implementation environment according to an embodiment of this disclosure.

FIG. 2 is a flowchart of an item placement method according to an embodiment of this disclosure.

FIG. 3 is a flowchart of another item placement method according to an embodiment of this disclosure.

FIG. 4 is a schematic diagram of a virtual scene interface according to an embodiment of this disclosure.

FIG. 5 is a schematic diagram of another virtual scene interface according to an embodiment of this disclosure.

FIG. 6 is a schematic diagram of another virtual scene interface according to an embodiment of this disclosure.

FIG. 7 is a schematic diagram of another virtual scene interface according to an embodiment of this disclosure.

FIG. 8 is a flowchart of another item placement method according to an embodiment of this disclosure.

FIG. 9 is a flowchart of another item placement method according to an embodiment of this disclosure.

FIG. 10 is a flowchart of another item placement method according to an embodiment of this disclosure.

FIG. 11 is a flowchart of another item placement method according to an embodiment of this disclosure.

FIG. 12 is a schematic structural diagram of an item placement apparatus according to an embodiment of this disclosure.

FIG. 13 is a schematic structural diagram of another item placement apparatus according to an embodiment of this disclosure.

FIG. 14 is a schematic structural diagram of another item placement apparatus according to an embodiment of this disclosure.

FIG. 15 is a schematic structural diagram of a terminal according to an embodiment of this disclosure.

FIG. 16 is a schematic structural diagram of a server according to an embodiment of this disclosure.

### DESCRIPTION OF EMBODIMENTS

To make objectives, technical solutions, and advantages of embodiments of this disclosure clearer, examples of implementations of this disclosure are described below in further detail with reference to drawings.

Terms “first”, “second”, “third”, “fourth”, “fifth”, “sixth”, and the like used in this disclosure may be configured for describing various concepts in this specification. However, unless otherwise specified, the concepts are not limited by the terms. The terms are merely configured for distinguishing one concept from another. For example, without departing from the scope of this disclosure, a first placed state may be referred to as a second placed state, and similarly, the second placed state may be referred to as the first placed state.

In terms “at least one”, “a plurality of”, “each”, and “any one” used in this disclosure, “at least one” includes one, two, or more, “a plurality of” include two or more, “each” refers to each of a plurality of corresponding items, and “any one” refers to any one of a plurality of items. For example, a plurality of battle rounds include 3 battle rounds, “each” refers to each of the 3 battle rounds, and “any one” refers to any one of the 3 battle rounds, which may be the first battle round, the second battle round, or the third battle round.

For ease of understanding of the embodiments of this disclosure, terms involved in the embodiments of this disclosure are first described. The descriptions of the terms are provided as examples only and are not intended to limit the scope of the disclosure.
Auto Chess: It is a new multiplayer strategy game, in which a user arranges a chess piece formation at his/her discretion, which battles with rival formations. A losing user is subjected to deduction of a virtual health point. A user having a virtual health point less than a threshold is eliminated. All users are ranked based on an order of elimination, with a final survival user winning the game.
Virtual battle: It refers to a game battle in which a plurality of players participate. The virtual battle includes a plurality of battle rounds. In some embodiments, each battle round includes a preparation stage and a battle stage. In the preparation stage, a user may arrange a virtual chess piece formation, and arrange chess pieces on a chessboard. In the battle stage, virtual chess pieces engage in the battle at his/her discretion based on virtual chess piece formations of both parties until all virtual chess pieces of a party are defeated. The party of which all of the virtual chess pieces are defeated is a defeated party in the current battle round.
Virtual chess pieces: They are battle units in the Auto Chess, which are different from each other. A user may perform operations on his/her virtual chess pieces, such as arming, upgrading, purchasing, selling, and position adjustment.
Virtual chessboard: Each user corresponds to a home chessboard, and arranges a formation on the home chessboard in a preparation stage. In a battle stage, virtual chess pieces corresponding to the user are transferred to a home chessboard of a rival (in some cases, virtual chess pieces of the rival are transferred to the home chessboard of the user) for battle.
Jungling round: It is a battle round among a plurality of battle rounds included in a virtual battle, in which a battle with a system-created virtual monster is performed and which excludes a battle round in which a battle with other users is performed. In the jungling round, the user may battle with the virtual monster through an arranged virtual chess piece formation. In a case that the virtual monster is defeated, a virtual item is dropped for the user to pick up and use in the virtual battle.
Key item: It is a virtual item in the Auto Chess that can affect a battle result of a virtual battle. For example, the key item is a “Population item” or a “Role change token item”.
Population item: It is configured to increase a number of virtual chess pieces participating in a battle.
Role change token item: It is an arming item that may be worn on a virtual chess piece. In a case that a role change token item is worn on a virtual chess piece, a constraint may be generated to other virtual chess pieces based on an attribute of the role change token item. A role change token item includes for example a “Shooter token”, a “Master token”, a “Warrior token”, and a “Chang'an token”.
Constraint: It can provide additional strength for virtual chess pieces. Activation of the constraint requires at least two virtual chess pieces having the constraint to simultaneously participate in a battle. A virtual chess piece wearing a role change token item is equivalent to getting involved in the constraint. A larger number of different constraints generated between a virtual chess piece and other virtual chess pieces indicate a larger number of constraint layers corresponding to the virtual chess piece, and thereby indicate a stronger additional functional capability obtained by the virtual chess piece.
Core item: It is a material configured to strengthen an item, and it can strengthen ordinary single items into a more powerful final item.
Transformation token item: It is configured to be transformed into a role change token item. In a case that the transformation token item is not worn, in a preparation stage of each battle round, the transformation token item is transformed to a role change token item. In a case that the transformation token item is worn by a virtual chess piece, the transformation token item no longer changes, and remains the role change token item currently transformed to.
Talent item: It is configured to add a talent to a virtual chess piece of a user, to improve a capability of the virtual chess piece.
Gold coin item: It is configured to purchase a virtual chess piece.

In the related art, a virtual item is usually placed at a random moment during a virtual battle. However, since this virtual item placement manner has high randomness, a user does not learn virtual item appearance time, resulting in poor user experience.

An item placement method provided in the embodiments of this disclosure may be performed by a computer device. In some embodiments, the computer device may be a terminal or a server. In some embodiments, the server is an independent physical server, a server cluster composed of a plurality of physical servers or a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform. In some embodiments, the terminal is a smart phone, a tablet computer, a notebook computer, a desktop computer, a smart speaker, a smart watch, a smart voice interaction device, a smart household appliance, an on-board terminal, or the like, which is not limited thereto.

In some embodiments, computer programs involved in the embodiments of this disclosure may be deployed on a computing computer device for execution, or may be executed on a plurality of computing devices at one location, or may be executed on a plurality of computing devices distributed at a plurality of locations and connected by a communication network. The plurality of computer devices distributed at the plurality of locations and connected by the communication network can form a blockchain system.

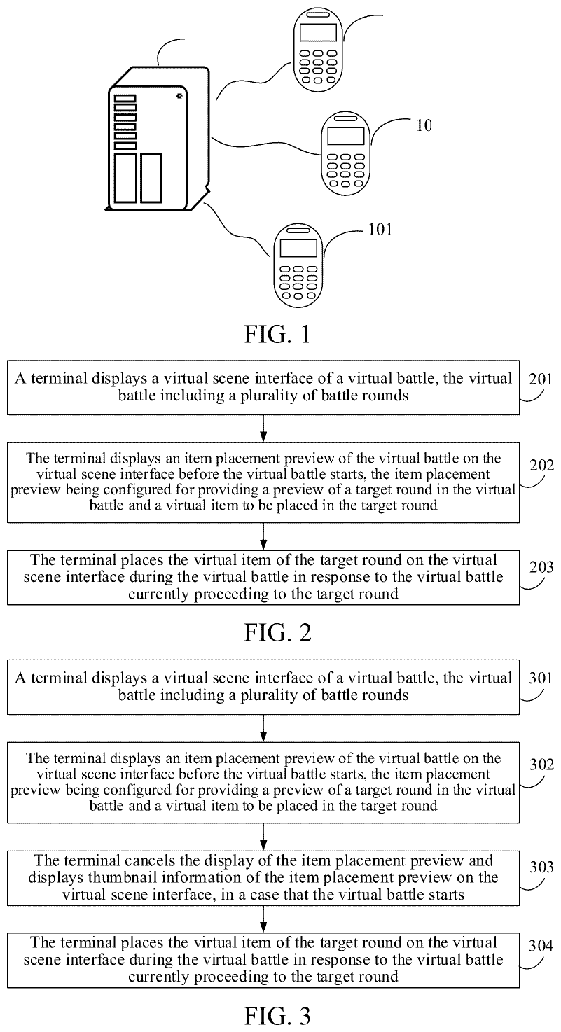

FIG. 1 is a schematic diagram of an implementation environment according to an embodiment of this disclosure. Referring to FIG. 1, the implementation environment includes a plurality of terminals 101 (3 terminals are used as an example in FIG. 1) and a server 102. The terminals 101 and the server 102 are directly or indirectly connected through wired or wireless communication.

The server 102 is configured to provide a virtual scene interface of a virtual battle for the plurality of terminals 101, and provide an item placement preview on the virtual scene interface, so that each terminal 101 can display the virtual scene interface and display the item placement preview on the virtual scene interface before the virtual battle starts. Moreover, the server 102 can further place a virtual item based on the item placement preview during the virtual battle, so that each terminal 101 can display the placed virtual item on the virtual scene interface during the battle.

In some embodiments, each terminal 101 has a target application served by the server 102 installed therein. The target application has a function of performing virtual battles. For example, the target application is an Auto Chess game application. Each terminal 101 logs in the target application based on an object identifier. The server 102 creates a virtual battle for the object identifiers logged in the plurality of terminals 101. The plurality of terminals 101 participate in the virtual battle based on the logged object identifiers.

According to an aspect, a method for item placement in a virtual battle is provided. In the method, an item placement preview of the virtual battle is displayed before the virtual battle starts. The item placement preview is configured to provide a preview of a target round of a plurality of battle rounds in the virtual battle and a virtual item to be placed in the target round. A virtual scene of the virtual battle is displayed when the virtual battle starts. The virtual item of the target round is added to the displayed virtual scene during the virtual battle when the virtual battle proceeds to the target round.

FIG. 2 is a flowchart of an item placement method according to an embodiment of this disclosure. The method is performed by a terminal, for example. As shown in FIG. 2, the method includes the following operations:
201: A terminal displays a virtual scene interface of a virtual battle, the virtual battle including a plurality of battle rounds.

The virtual scene interface is configured to display a virtual scene of the virtual battle. The virtual battle includes a plurality of battle rounds. During the virtual battle, the plurality of battle rounds are performed in sequence.

In this embodiment of this disclosure, in a case that the terminal participates in the virtual battle, the terminal can display the virtual scene interface of the virtual battle, to display information about the virtual battle subsequently on the virtual scene interface. In some embodiments, the terminal participates in the virtual battle based on a logged object identifier.
202: The terminal displays an item placement preview of the virtual battle on the virtual scene interface before the virtual battle starts, the item placement preview being configured for providing a preview of a target round in the virtual battle and a virtual item to be placed in the target round.

The target round is any one of the plurality of battle rounds included in the virtual battle, and one or more target rounds may exist. The virtual item is an item of any type. For example, the virtual item is a population item, a role change token item, a core item, a transformation token item, a talent item, or a gold coin item.

In this embodiment of this disclosure, before the virtual battle starts, i.e., before the plurality of battle rounds included in the virtual battle start, the item placement preview of the virtual battle is displayed on the virtual scene interface, to provide a preview of battle rounds in which virtual items are to be placed subsequently and the to-be-placed virtual items during the virtual battle, so that a user can learn the information about the item placement in the virtual battle in advance.
203: The terminal places the virtual item of the target round on the virtual scene interface during the virtual battle in response to the virtual battle currently proceeding to the target round.

In this embodiment of this disclosure, the virtual battle includes a plurality of battle rounds. During the virtual battle, the virtual item is placed based on the item placement preview. In other words, if the virtual battle currently proceeds to the target round in the item placement preview, the virtual item of the target round is placed on the virtual scene interface, and the placed virtual item is displayed, so that the user controls a virtual object to pick up the placed virtual item. The virtual item of the target round is the virtual item in the item placement preview to be placed in the target round.

In solutions provided in the embodiments of this disclosure, before the virtual battle starts, the preview of the target round of the virtual battle and the virtual item to be placed in the target round is provided, and in a case that the virtual battle proceeds to the target round, the virtual item of the target round is placed, so that a user can learn information about virtual item placement in the virtual battle in advance. In this way, the user can make a strategical layout on the virtual battle based on the information about the virtual item placement, which improves control of the virtual battle by the user, thereby improving user experience.

Based on the embodiment shown in FIG. 2, in the embodiments of this disclosure, during the virtual battle, the information about the virtual item placement may be further displayed through thumbnail information of the item placement preview, thereby ensuring an effect of the preview. For a specific process, reference is made to the following embodiment.

FIG. 3 is a flowchart of another item placement method according to an embodiment of this disclosure. The method is performed by a terminal, for example. As shown in FIG. 3, the method includes the following operations:
301: A terminal displays a virtual scene interface of a virtual battle, the virtual battle including a plurality of battle rounds.

In a possible implementation, a plurality of object identifiers participating in the virtual battle and a scene image of the virtual battle are displayed on the virtual scene interface. The scene image is configured for displaying a virtual scene in the virtual battle. For example, the scene image is displayed as a chessboard.

In a possible implementation, a process of displaying the virtual scene interface by the terminal includes: displaying, by the terminal, the virtual scene interface of the virtual battle in a case that the object identifiers participate in the virtual battle.
302: The terminal displays an item placement preview of the virtual battle on the virtual scene interface before the virtual battle starts, the item placement preview being configured for providing a preview of a target round in the virtual battle and a virtual item to be placed in the target round.

In a possible implementation, the item placement preview includes a round identifier and an item identifier. The round identifier indicates the target round. The item identifier indicates the virtual item to be placed in the target round or an item type of the to-be-placed virtual item.

In this embodiment of this disclosure, a battle round in which a virtual item is to be placed and virtual items to be placed in the virtual battle are indicated through the round identifier and the item identifier included in the item placement preview, which improves a display effect of the item placement preview, thereby improving a preview effect, and improving user experience.

In some embodiments, the item placement preview includes a plurality of round identifiers and an item identifier corresponding to each round identifier.

Each round identifier indicates a target round, and different round identifiers indicate different target rounds. The item identifier corresponding to each round identifier indicates a virtual item to be placed in a target round corresponding to the round identifier or an item type of the to-be-placed virtual item. In some embodiments, different round identifiers correspond to different item identifiers. For example, the item placement preview includes 3 round identifiers and an item identifier corresponding to each round identifier.

In this embodiment of this disclosure, the item placement preview includes the plurality of round identifiers and the item identifier corresponding to each round identifier, to provide a preview indicating that virtual items are subsequently placed at a plurality of times during the virtual battle, so that a user can learn information about virtual item placement of a plurality of target rounds in the virtual battle, which enriches virtual items to be placed in the virtual battle, makes the virtual battle funnier, and improves the display effect of the item placement preview, thereby improving the preview effect. Moreover, in a case that the item identifier corresponding to the round identifier indicates the item type of the virtual item to be placed in the target round corresponding to the round identifier, the user can learn only the item type of the virtual item to be placed in the target round, and cannot learn the to-be-placed virtual item of the item type. In this way, randomness is achieved for the virtual battle, which improves attractiveness to the user, thereby improving the user experience.

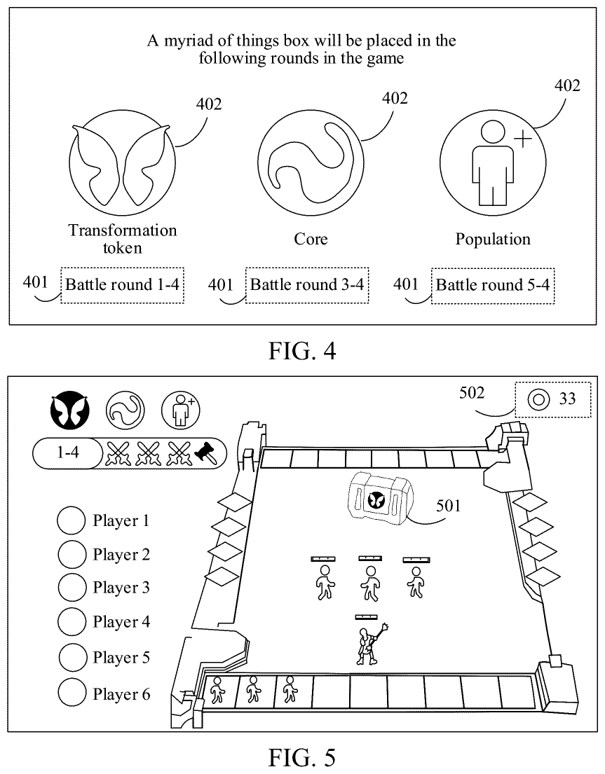

As shown in FIG. 4, the item placement preview of the virtual battle displayed on the virtual scene interface includes 3 round identifiers 401 and an item identifier 402 corresponding to each round identifier 401. In a battle round 1-4, a transformation token item is placed, in a battle round 3-4, a core item is placed, and in a battle round 5-4, a population item is placed.

In some embodiments, the virtual item of the item placement preview is a key item, which can affect a battle result of the virtual battle.
303: The terminal cancels the display of the item placement preview and displays thumbnail information of the item placement preview on the virtual scene interface, in a case that the virtual battle starts.

In this embodiment of this disclosure, in a case that the virtual battle starts, the display of the item placement preview is canceled, and the thumbnail information of the item placement preview is displayed on the virtual scene interface, to prevent the displayed item placement preview from affecting display of information about the battle on the virtual scene interface. Therefore, not only the preview of the information about the virtual item placement in the virtual battle can be provided on the virtual scene interface, but also the information about the battle can be normally displayed on the virtual scene interface, which enriches content displayed on the virtual scene interface, and ensures the display effect. In addition, the preview of the information about the item placement in the virtual battle can be provided during the virtual battle, which ensures the preview effect, thereby improving the user experience.

In a possible implementation, the virtual scene interface includes a first display region and a second display region. A size of the first display region is less than a size of the second display region. A process of displaying the thumbnail information includes: displaying the thumbnail information in the first display region, and displaying the scene image of the virtual battle in the second display region.

The first display region is any region on the virtual scene interface. For example, the first display region is an upper left region of the virtual scene interface.

In this embodiment of this disclosure, the information about the virtual battle may be displayed in the second display region, and the thumbnail information is displayed in the first display region with a smaller size, so that not only the information about the virtual battle can be normally displayed on the virtual scene interface, but also the preview of the information about the item placement in the virtual battle can be provided, thereby ensuring the display effect.

In a possible implementation, the thumbnail information includes a plurality of item identifiers (icons). Each item identifier corresponding to a target round, and each item identifier indicates a virtual item or an item type. In other words, the thumbnail information can indicate virtual items to be placed in a plurality of target rounds included in the virtual battle or item types of the to-be-placed virtual items. Item identifiers corresponding to the plurality of target rounds are displayed in the thumbnail information, to provide the preview of the information about the virtual item placement of the virtual battle, which ensures the preview effect, thereby improving the user experience.
304: The terminal places the virtual item of the target round on the virtual scene interface during the virtual battle in response to the virtual battle currently proceeding to the target round.

In a possible implementation, operation 304 includes: placing the virtual item of the target round on the virtual scene interface in response to the virtual battle currently proceeding to the target round and the target round ending.

In this embodiment of this disclosure, the virtual item is placed after the target round ends, to avoid impact of the virtual item placement on a battle situation in the target round currently in progression, so that the user can control a virtual object to pick up the virtual item, thereby ensuring a normal operation of the game. After controlling the virtual object to pick up the virtual item, the user may use the virtual item in a battle round after the target round.

In some embodiments, a process of placing the virtual item includes: displaying an item placement round in response to the virtual battle currently proceeding to the target round and the target round ending, and placing the virtual item in the item placement round on the virtual scene interface.

The item placement round is added after the target round, so that the user can pick up the virtual item in the item placement round without affecting the battle round in the virtual battle, which ensures a battle effect of the virtual battle, and improves the user experience.

In some embodiments, the item placement round corresponds to a first target duration. When a duration of the item placement round reaches the first target duration, the battle round after the target round starts.

In this embodiment of this disclosure, after the virtual item is placed in the item placement round, the user can control the virtual object to pick up the virtual item. Regardless of whether the virtual item is picked up, in a case that the duration of the item placement round reaches the first target duration, the battle round after the target round is immediately enabled. Setting the duration of the item placement round can not only ensure that the user has sufficient time to control the virtual object to pick up the virtual item, but also avoid impact of an excessively long item placement round on progression of the virtual battle, which ensures the battle effect of the virtual battle, thereby improving the user experience.

In some embodiments, in an Auto Chess, a virtual object that may be controlled by the user is a virtual chess piece.

In some embodiments, after the virtual item is placed in the item placement round, the user can control the virtual object to pick up the virtual item. In a case that the virtual item is picked up, the display of the virtual item is canceled. In a case that the duration of the item placement round reaches the first target duration, the battle round after the target round starts. In a case that the duration of the item placement round reaches the first target duration, if the placed virtual item is not picked up, the virtual item is canceled, and the battle round after the target round starts.

As shown in FIG. 5, the item placement preview includes a battle round 1-4 and a virtual item to be placed in the battle round 1-4. In a case that the virtual battle currently proceeds to the battle round 1-4, a virtual item 501 of the battle round 1-4 is placed on the virtual scene interface, and a countdown 502, for example, 33 seconds, is displayed on the virtual scene interface, to prompt the user to control the virtual object to pick up the virtual item 501 within the 33 seconds. After the countdown ends, a next battle round starts.

In some embodiments, each battle round of the virtual battle includes a preparation stage and a battle stage. After the item placement round ends, a preparation stage of the battle round after the target round starts.

In some embodiments, the preparation stage of each battle round corresponds to a second target duration. In this case, the item placement round and the preparation stage of the battle round after the target round may be combined into one stage. In other words, after the target round ends, a preparation stage of a next battle round is directly enabled. In this case, a duration of the preparation stage is a sum of the first target duration and the second target duration, and a to-be-placed virtual item is displayed in the preparation stage. In a case that the duration of the preparation stage reaches the first target duration, the display of the virtual item is canceled. In a case that the duration of the preparation stage reaches the sum of the first target duration and the second target duration, the battle stage starts.

The item placement round after the target round and the preparation stage of the battle round after the target round are combined into one stage, so that repeated switching between content displayed on the virtual scene interface is avoided, thereby ensuring the display effect.

In a possible implementation, each battle round of the virtual battle includes a preparation stage and a battle stage. In response to the virtual battle currently proceeding to the target round, the virtual item of the target round is placed on the virtual scene interface in a preparation stage of the target round.

In some embodiments, the preparation stage of the target round corresponds to a third target duration. After the virtual item is placed in the preparation stage of the target round, the user can control the virtual object to pick up the virtual item. In a case that the virtual item is picked up, the display of the virtual item is canceled. In a case that a duration of the preparation stage of the target round reaches the third target duration, a battle stage of the target round starts. In a case that the duration of the preparation stage of the target round reaches the third target duration, if the placed virtual item is not picked up, the virtual item is canceled, and the battle stage of the target round starts.

In some embodiments, a preparation stage of a non-target round corresponds to the second target duration. The third target duration is greater than the second target duration. The non-target round refers to a battle round among the plurality of battle rounds of the virtual battle other than the target round.

In this embodiment of this disclosure, the virtual item is placed in the preparation stage of the target round, to avoid impact of the virtual item placement on a battle situation in the battle stage of the target round, so that the user can control the virtual object to pick up the virtual item, thereby ensuring the normal operation of the game. After controlling the virtual object to pick up the virtual item, the user can use the virtual item in the battle stage of the target round and in the battle round after the target round.

In a possible implementation, in a case that the item placement preview is configured for providing the preview of the item type of the virtual item to be placed in the target round, the process of placing the virtual item includes: randomly determining a virtual item from virtual items of the item type of the target round in response to the virtual battle currently proceeding to the target round, and placing the determined virtual item on the virtual scene interface. In other words, only the preview of the item type of the virtual item to be placed in the target round is provided, and the preview of the specific placed virtual item is not provided. A random virtual item of the item type is placed in the target round subsequently.

In some embodiments, one or more random virtual items may be determined. In some embodiments, in a case that a plurality of random virtual items are determined, the virtual object can pick up only one of the plurality of virtual items.

In this embodiment of this disclosure, a virtual item to be placed in the target round is randomly determined from the virtual items of the item type of the target round. In this way, not only the user can learn the item type of the to-be-placed virtual item, but also randomness of the to-be-placed virtual item is ensured, thereby improving the user experience.

In a possible implementation, in a case that the virtual item of the target round is placed on the virtual scene interface, the method further includes: displaying the virtual object moving to a position of the virtual item on the virtual scene interface to obtain the virtual item. In other words, the virtual item is delivered to the virtual object in response to the virtual object moving to the position of the virtual item.

In this embodiment of this disclosure, through control of the virtual object to move to the position of the virtual item, pickup of the virtual item can be achieved, which ensures convenience of picking up the virtual item.

In some embodiments, the placed virtual item is displayed in a form of an item box on the virtual scene interface. In this case, a process of obtaining the virtual item includes: displaying the virtual object moving to a position of the item box on the virtual scene interface, to open the item box and obtain the virtual item included in the item box. For example, the item box is a myriad of things box. In other words, in a case that the virtual object moves to the position of the item box, in response to an opening operation performed on the item box, the virtual item included in the item box is delivered to the virtual object. In some embodiments, the opening operation may be a clicking/tapping operation performed on the item box, a clicking/tapping operation performed on an opening option of the item box, or the like. In some embodiments, the virtual object moving to the position of the item box means that a distance between the virtual object and the item box is not greater than a distance threshold, or the like.

In some embodiments, in a case that the item box is opened, a plurality of virtual items of the same item type are displayed. In response to a selection operation performed on any virtual item, the selected virtual item is obtained. In other words, in response to the opening operation performed on the item box, the plurality of virtual items of the item type are displayed. In response to the selection operation performed on any virtual item, the selected virtual item is delivered to the virtual object.

In some embodiments, in a case that the virtual object picks up the virtual item, an item option is displayed on the virtual scene interface. The item option is filled with an item identifier corresponding to the picked virtual item, so that the user can trigger the item option to use the virtual item. The terminal uses the virtual item in the virtual battle in response to the triggering operation performed on the item option of the virtual item.

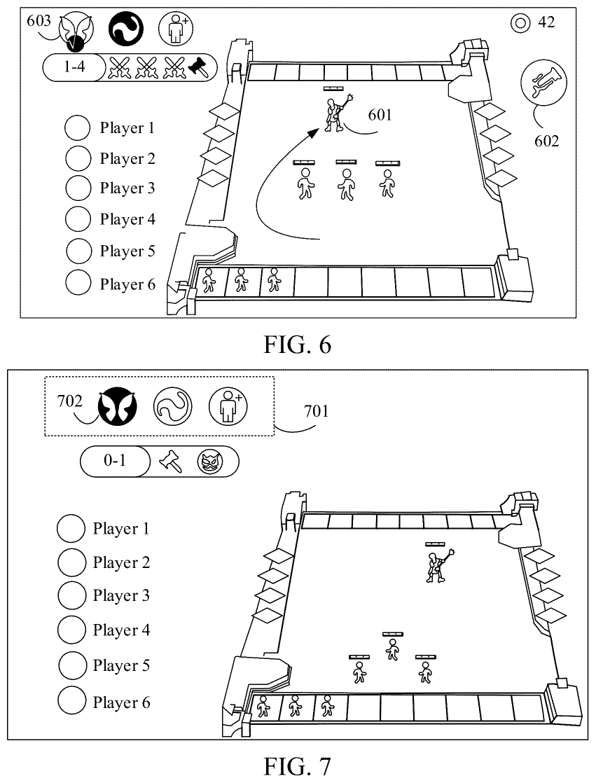

For example, in an Auto Chess, each user corresponds to a home chessboard. In a preparation stage of a target round, the home chessboard is displayed on the virtual scene interface. The user may arrange a formation on the home chessboard. In a battle stage of the target round, virtual chess pieces corresponding to the user are transferred to a home chessboard of a rival for battle, or virtual chess pieces of the rival are transferred to a home chessboard of the user for battle, and a battle picture is displayed on the virtual scene interface. After the battle ends (i.e., the target round ends), the home chessboard is displayed on the virtual scene interface, a myriad of things box of the target round is placed on the home chessboard, and the user may control a virtual chess piece to move to a position of the myriad of things box, to open the myriad of things box and obtain a virtual item included in the myriad of things box. As shown in FIG. 6, in a case that a virtual object 601 is controlled to move to a position of a virtual item, display of the virtual item is canceled, and an item option 602 is displayed on the virtual scene interface, to indicate that the virtual item is obtained.

This embodiment of this disclosure is described by using any terminal participating in the virtual battle as an example. Each terminal participating in the virtual battle may place a virtual item based on the above embodiment. For example, in a case that the virtual battle proceeds to the target round, each terminal participating in the virtual battle may place a virtual item of the target round on the virtual scene interface, and the virtual items placed by the terminals on the virtual scene interface do not affect each other. In other words, in a case that the virtual battle proceeds to the target round, a virtual item of the target round is placed for each user (i.e., a user corresponding to each terminal) participating in the virtual battle, and each user may control a virtual object to pick up the virtual item.

In a solution provided in this embodiment of this disclosure, before the virtual battle starts, the preview of the target round of the virtual battle and the virtual item to be placed in the target round is provided, and in a case that the virtual battle proceeds to the target round, the virtual item of the target round is placed, so that the user can learn the information about the virtual item placement in the virtual battle in advance. In this way, the user can make a strategical layout on the virtual battle based on the information about the virtual item placement, which improves control of the virtual battle by the user, thereby improving the user experience.

In this embodiment of this disclosure, in a case that the virtual battle starts, the display of the item placement preview is canceled, and the thumbnail information of the item placement preview is displayed on the virtual scene interface, to prevent the displayed item placement preview from affecting display of information about the battle on the virtual scene interface. Therefore, not only the preview of the information about the virtual item placement in the virtual battle can be provided on the virtual scene interface, but also the information about the battle can be normally displayed on the virtual scene interface, which enriches content displayed on the virtual scene interface, and ensures the display effect. In addition, the preview of the information about the item placement in the virtual battle can be provided during the virtual battle, which ensures the preview effect, thereby improving the user experience.

Moreover, in a case that the virtual item of the item placement preview is a key item that can affect the battle result of the virtual battle, a preview of the key item to be placed in the virtual battle and a placement moment (i.e., a target round in which the key item is to be placed) is provided before the virtual battle starts, so that the user can learn information about virtual item placement in the virtual battle in advance. In this way, the user can make a strategical layout on the virtual battle based on the information about the virtual item placement in the virtual battle, which avoids game unfairness as a result of the user being not notified of the placement moment of the key item, and improves control of the virtual battle by the user, thereby improving the user experience.

Based on the embodiment shown in FIG. 3, in a case that the thumbnail information includes a plurality of item identifiers, a process of displaying the thumbnail information includes the following two manners:

First manner: An item identifier corresponding to the target round about to start is highlighted as the virtual battle progresses in a case that the plurality of item identifiers are displayed on the virtual scene interface, the item identifier corresponding to the target round indicating the virtual item to be placed in the target round.

In this embodiment of this disclosure, during the virtual battle, a plurality of battle rounds are performed in sequence, and the target round about to start is a first target round after a battle round currently in progression. For example, the virtual battle includes 10 battle rounds. The 3^{rd} battle round, the 6^{th} battle round, and the 8^{th} battle round are target rounds. When the virtual battle starts or the 1^{st} battle round or the 2^{nd} battle round is currently in progression, an item identifier corresponding to the 3^{rd} battle round is highlighted. When the 4^{th} battle round or the 5^{th} battle round is currently in progression, an item identifier corresponding to the 6^{th} battle round is highlighted. When the 7^{th} battle round or the 8^{th} battle round is currently in progression, an item identifier corresponding to the 8^{th} battle round is highlighted.

In this embodiment of this disclosure, in a case that a plurality of item identifiers are displayed on the virtual scene interface, when the virtual battle proceeds to a target round, a virtual item corresponding to the target round is placed on the virtual scene interface, and an item identifier corresponding to the target round about to start is highlighted as the virtual battle progresses, to provide a preview of to-be-placed virtual items. In this way, the user can learn the to-be-placed virtual items in advance, which ensures that the user can plan a game strategy in advance, and ensures a preview effect, thereby improving the user experience.

As shown in FIG. 7, thumbnail information 701 displayed on the virtual scene interface includes 3 item identifiers. After the virtual battle starts, the 1^{st} item identifier 702 is highlighted. The 1^{st} item identifier 702 is an item identifier corresponding to the 1^{st} target round about to start.

In a possible implementation, a highlighting manner includes: highlighting the item identifier corresponding to the target round about to start and dimming other item identifiers, or flashing the item identifier corresponding to the target round about to start and maintaining other item identifiers stationary.

This embodiment of this disclosure is described by using the above two highlighting manners as examples. In another embodiment, another highlighting manner may be adopted, as long as the item identifier corresponding to the target round about to start can be indicated.

Second manner: An item identifier of a placed virtual item is displayed in a placed state and an item identifier of an unplaced virtual item is displayed in an unplaced state during the virtual battle in a case that the plurality of item identifiers are displayed on the virtual scene interface.

The placed state indicates that a virtual item indicated in the item identifier is placed in the virtual battle, which can indicate that the virtual battle proceeds to the target round corresponding to the item identifier. As shown in FIG. 6, an item identifier 603 is displayed in the placed state. The unplaced state indicates a virtual item indicated in the item identifier is not placed in the virtual battle, which can indicate that the virtual battle does not proceed to the target round corresponding to the item identifier.

In this embodiment of this disclosure, the item identifiers are displayed on the virtual scene interface in different states, to indicate information about virtual item placement in the virtual battle, which prompts a virtual item placement progress in the virtual battle. In this way, the user can learn the information about the virtual item placement in the virtual battle, thereby improve the user experience.

In some embodiments, the placed state includes a first placed state or a second placed state. That an item identifier is displayed in a placed state includes: displaying an item identifier of a virtual item that is placed but not picked up in the first placed state; and display an item identifier of a virtual item that is placed and picked up in the second placed state.

In this embodiment of this disclosure, during the virtual battle, in a case that the virtual battle proceeds to the target round, the virtual item is placed on the virtual scene interface. After the virtual item is placed, the placed virtual item may or may not be picked up. The item identifier of the placed virtual item is displayed in different manners depending on whether the placed virtual item is picked up, to indicate whether the placed virtual item is picked up, which ensures the display effect, thereby improving the user experience.

The above two thumbnail information displaying manners may be combined. For example, the item identifier corresponding to the target round about to start is highlighted as the virtual battle progresses, the item identifier of the placed virtual item is displayed in the placed state, and the item identifier of the unplaced virtual item is displayed in the unplaced state. In this way, the user can learn placed virtual items, unplaced virtual items, and virtual items about to be placed, which improves the display effect, thereby improving the user experience.

According to an aspect, an item placement method is provided. In the method, before the virtual battle starts, an item placement policy for the virtual battle is determined from a plurality of item placement policies, the virtual battle including a plurality of battle rounds. An item placement preview of the virtual battle is generated based on the determined item placement policy. The item placement preview is configured to provide a preview of a target round of the plurality of battle rounds in the virtual battle and a virtual item to be placed in the target round. The item placement preview is provided to a plurality of terminals that is associated with a plurality of players of the virtual battle. The item placement preview is displayed by the plurality of terminals before the virtual battle starts. The virtual item indicated by the item placement preview is added in a virtual scene of the virtual battle during the virtual battle.

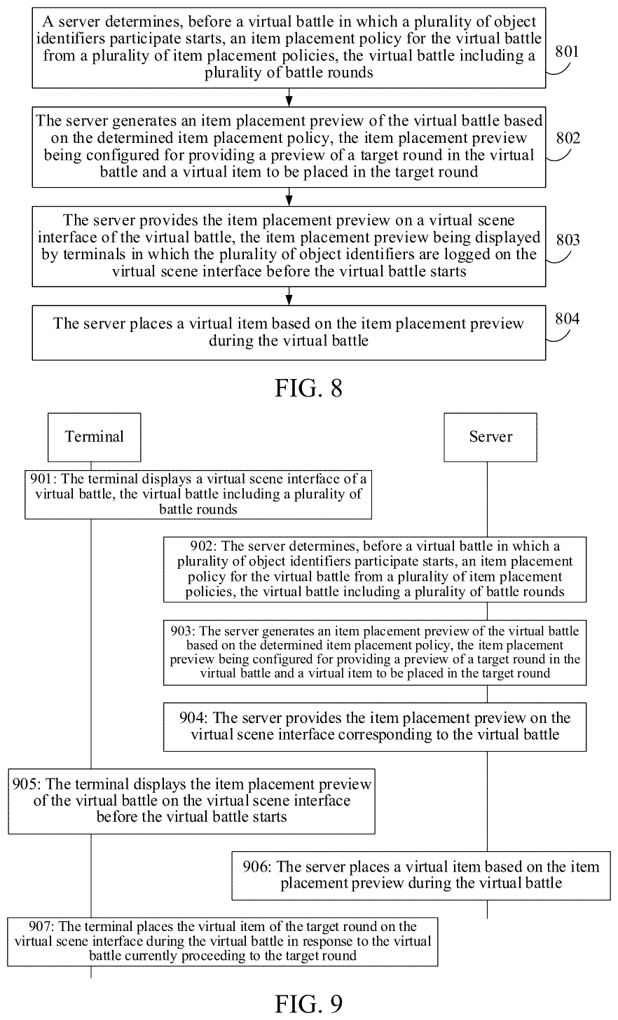

FIG. 8 is a flowchart of another item placement method according to an embodiment of this disclosure. The method is performed by a server, for example. As shown in FIG. 8, the method includes the following operations:
801: A server determines, before a virtual battle in which a plurality of object identifiers participate starts, an item placement policy for the virtual battle from a plurality of item placement policies, the virtual battle including a plurality of battle rounds.

Each object identifier is configured for representing an object participating in the virtual battle. For example, the object identifier is configured for representing a user participating in the virtual battle. In this embodiment of this disclosure, the virtual battle may have a plurality of object identifiers participating therein. To be specific, the plurality of object identifiers battle to be a winner, or the plurality of object identifiers cooperate with each other to battle with another virtual object. The item placement policy indicates information about virtual item placement in any virtual battle. In some embodiments, the item placement policy indicates a battle round in any virtual battle and a virtual item to be placed in the battle round, or the item placement policy indicates a virtual item to be placed in any virtual battle. In a plurality of item placement policies, different item placement policies indicate different information about item placement. For example, different item placement policies indicate different virtual items to be placed in the virtual battle, or different item placement policies indicate different target rounds in the virtual battle to which virtual items are to be placed.

In this embodiment of this disclosure, the server is configured with a plurality of item placement policies, and different item placement policies indicate different information about the virtual item placement. The item placement policy for the virtual battle is determined from the plurality of item placement policies, so that different item placement policies may be adopted for different virtual battles.
802: The server generates an item placement preview of the virtual battle based on the determined item placement policy, the item placement preview being configured for providing a preview of a target round in the virtual battle and a virtual item to be placed in the target round.

In this embodiment of this disclosure, the item placement preview of the virtual battle is generated based on the determined item placement policy of the virtual battle, so that a preview of information about virtual item placement in the virtual battle can be subsequently provided by using the item placement preview.
803: The server provides the item placement preview on a virtual scene interface of the virtual battle, the item placement preview being displayed by terminals in which the plurality of object identifiers are logged on the virtual scene interface before the virtual battle starts.

In this embodiment of this disclosure, the terminals participate in the virtual battle based on the logged object identifiers. The plurality of terminals in which the object identifiers are logged are a plurality of terminals participating in the virtual battle. During the virtual battle participated by the plurality of terminals, each terminal can display the virtual scene interface of the virtual battle. After determining the item placement preview of the virtual battle, the server provides the item placement preview on the virtual scene interface, so that all of the plurality of terminals can display the item placement preview. In this way, each object participating in the virtual battle can learn the information about the item placement during the subsequent virtual battle.
804: The server places a virtual item based on the item placement preview during the virtual battle.

In this embodiment of this disclosure, during the virtual battle, the server places the virtual item based on a battle round and a virtual item to be placed in the battle round in the item placement preview, so that the virtual item placed in the virtual battle is consistent with the item placement preview. In this way, the item placement preview achieves a preview function.

In solutions provided in this embodiment of this disclosure, the server determines the item placement policy for the virtual battle, and generates the item placement preview for the plurality of object identifiers participating in the virtual battle, to provide the preview of the battle round in the virtual battle in which the virtual item is to be placed and the placed virtual item before the virtual battle starts, so that the user learns the information about the virtual item placement in the virtual battle in advance, and the same item placement preview is shared among the plurality of object identifiers in the virtual battle, so that information about the virtual item placement for the plurality of object identifiers participating in the same virtual battle is consistent. In this way, game unfairness as a result of placement of inconsistent virtual items can be eliminated, game competitiveness can be ensured, and it can be ensured that the user can plan a game strategy based on the information about the virtual item placement in the virtual battle, which improves control of the virtual battle by the user, thereby improving user experience.

Based on the above embodiments shown in FIG. 2 and FIG. 8, the item placement method provided in the embodiments of this disclosure is implemented through an interaction between the terminal and the server. The server is configured to serve the terminal, so that the terminal can display the virtual scene interface of the virtual battle. For a specific process, reference is made to the following embodiment.

FIG. 9 is a flowchart of an item placement method according to an embodiment of this disclosure. The method is performed by a terminal and a server, for example. As shown in FIG. 9, the method includes the following operations:
901: A terminal displays a virtual scene interface of a virtual battle, the virtual battle including a plurality of battle rounds.
902: A server determines, before a virtual battle in which a plurality of object identifiers participate starts, an item placement policy for the virtual battle from a plurality of item placement policies, the virtual battle including a plurality of battle rounds.

In a possible implementation, operation 902 includes: determining the item placement policy corresponding to the virtual battle from the plurality of item placement policies based on historical battle information of the plurality of object identifiers.

The historical battle information of the object identifiers includes information about a historical virtual battle participated by the object identifiers. In some embodiments, the historical battle information includes a plurality of object identifiers participating in the historical virtual battle, an item placement preview displayed in the historical virtual battle, an item placement policy for the historical virtual battle, and the like.

In this embodiment of this disclosure, the item placement policy for the virtual battle may be determined from the plurality of item placement policies based on the historical battle information of the plurality of object identifiers participating in the virtual battle, to ensure that the determined item placement policy matches the plurality object identifiers, and ensure a subsequent item placement effect.

In some embodiments, a process of determining the item placement policy for the virtual battle includes: determining numbers of times the item placement policies included in the historical battle information of the plurality of object identifiers are used, and determining an item placement policy with a minimum number of times from the plurality of item placement policies as the item placement policy for the virtual battle based on the determined numbers of times.

The item placement policy with the minimum number of times is selected as an item placement policy for a current virtual battle based on the numbers of times the item placement policies included in the historical battle information are used, to enrich diversity of the virtual battle, and ensure a battle effect of the virtual battle, thereby improving user experience.

In a possible implementation, an item placement policy corresponds to a probability. The probability indicates a possibility that the item placement policy is selected. Operation 902 includes: determining the item placement policy for the virtual battle based on probabilities corresponding to the plurality of the item placement policies.

In this embodiment of this disclosure, an item placement policy is determined for each virtual battle based on the probabilities corresponding to the plurality of the item placement policies, to ensure that numbers of times item placement policies determined for a plurality of virtual battles are used match probabilities corresponding to the item placement policies, thereby ensuring randomness.

In a possible implementation, the item placement policy includes at least one sub-policy. In this case, the process of determining the item placement policy for the virtual battle includes: randomly determining an item placement policy from the plurality of item placement policies, and randomly selecting a sub-policy from sub-policies included in the determined item placement police as the item placement policy for the virtual battle.

For example, the plurality of item placement policies are shown in Table 1. Each item placement policy includes item types of virtual items to be placed in 3 target rounds. Different item placement policies may correspond to different probabilities. For example, a probability corresponding to an item placement policy may be a normal probability or a low probability. A probability that an item placement policy with a low probability is selected is less than a probability that an item placement policy with a normal probability is selected. In different item placement policies, the item types of virtual items to be placed in the 3 target rounds are not exactly the same. Different item placement policies can generate different effects. For example, an effect of an item placement policy 1 and an item placement policy 2 is that a large number of constraints can be generated for a large population participating in the virtual battle (i.e., a large number of virtual chess pieces participate in the virtual battle). For example, the item placement policy 1 includes 2 sub-policies. In the 2 sub-policies, virtual items to be placed in a target round 1 are of different item types. In one of the sub-policies, a virtual item to be placed in the target round 1 is a role change token item, and in the other of the sub-policies, a virtual item to be placed in the target round 1 is a core item.

TABLE 1

| Item | | | | | |
|---|---|---|---|---|---|
| placement | | Target | Target | Target | Policy |
| policy | Probability | round 1 | round 2 | round 3 | description |
| Item | Normal | Role change/Core | Population | Population | The |
| placement | probability | | | | strategy |
| policy 1 | | | | | can |
| | | | | | generate a |
| | | | | | large |
| Item | Normal | Population | Various | Population | number of |
| placement | probability | | items | | constraints |
| policy 2 | | | | | for a large |
| | | | | | population |
| Item | Low | Population | Population | Population | The |
| placement | probability | | | | strategy |
| policy 3 | | | | | can |
| | | | | | generate a |
| | | | | | large |
| | | | | | number of |
| | | | | | constraints |
| | | | | | for a large |
| | | | | | population |
| Item | Normal | Role change | Role change | Population/ | The |
| placement | probability | | | Gold coin | strategy |
| policy 4 | | | | | can |
| Item | Normal | Role change | Population/ | Role | generate |
| placement | probability | | Gold coin | change | different |
| policy 5 | | | | | constraints |
| Item | Normal | Transformation token | Role change | Population/ | for |
| placement | probability | | | Gold coin | abundant |
| policy 6 | | | | | role |
| Item | Normal | Transformation token | Population/ | Role | changes |
| placement | probability | | Gold coin | change | and a small |
| policy 7 | | | | | population |
| Item | Normal | Population/Role change/Gold | Dual core | Dual core | |
| placement | probability | coin | | | |
| policy 8 | | | | | |
| Item | Normal | Role | Dual core | Population | |
| placement | probability | change/Transmogrification | | | |
| policy 9 | | token/Talent | | | |
| Item | Normal | Role | Population | Dual core | |
| placement | probability | change/Transmogrification | | | |
| policy 10 | | token/Talent | | | |
| Item | Normal | Role change/Transformation | Talent | Population | The |
| placement | probability | token | | | strategy |
| policy 11 | | | | | can |
| | | | | | improve a |
| Item | Normal | Talent | Role | Population | capability |
| placement | probability | | change/Dual | | of virtual |
| policy 12 | | | core | | chess |
| | | | | | pieces |

903: The server generates an item placement preview of the virtual battle based on the determined item placement policy, the item placement preview being configured for providing a preview of a target round in the virtual battle and a virtual item to be placed in the target round.

In a possible implementation, the item placement policy includes a target number of to-be-placed virtual items. In this case, a process of generating the item placement preview includes: randomly selecting a target number of battle rounds from the plurality of battle rounds included in the virtual battle as target rounds, and generating an item placement preview based on the target rounds and the target number of the to-be-placed virtual items included in the item placement policy, the item placement preview including a round identifier and an item identifier, and being configured for providing a preview indicating that a virtual item indicated in the item identifier is to be placed in a target round indicated in the round identifier in the virtual battle.

In this embodiment of this disclosure, the target round is randomly determined from the plurality of battle rounds included in the virtual battle, to ensure randomness of the virtual battle, thereby ensuring a battle effect of the virtual battle, and improving the user experience.

In a possible implementation, the item placement policy includes a target number of to-be-placed virtual items. In this case, a process of generating the item placement preview includes: determining a target number of auction rounds of the plurality of battle rounds included in the virtual battle as target rounds, and generating an item placement preview based on the target rounds and the target number of the to-be-placed virtual items included in the item placement policy, the item placement preview including a round identifier and an item identifier, and being configured for providing a preview indicating that a virtual item indicated in the item identifier is to be placed in a target round indicated in the round identifier in the virtual battle.

The auction rounds are configured for auctioning virtual items for the plurality of object identifiers participating in the virtual battle. The auction rounds are selected as the target rounds, so that a user can not only auction virtual items during the auction rounds, but also obtain placed virtual items, which enriches combined usage manners of virtual items, thereby improving the user experience.
904: The server provides the item placement preview on the virtual scene interface corresponding to the virtual battle.
905: The terminal displays the item placement preview of the virtual battle on the virtual scene interface before the virtual battle starts.

In this embodiment of this disclosure, the server provides the item placement preview on the virtual scene interface, so that the terminal participating in the virtual battle can display the item placement preview on the virtual scene interface before the virtual battle starts. In this way, the user can learn information about virtual item placement of the virtual battle.

In a possible implementation, in a case that the server generates the item placement preview, the server transmits the item placement preview to a plurality of terminals participating in the virtual battle, so that each terminal participating in the virtual battle displays the item placement preview of the virtual battle on the virtual scene interface before the virtual battle starts.
906: The server places a virtual item based on the item placement preview during the virtual battle.

In this embodiment of this disclosure, during the virtual battle, the server places, based on the target round and the virtual item to be placed in the target round in the item placement preview, the virtual item of the target round in the target round in response to the virtual battle proceeding to the target round.
907: The terminal places the virtual item of the target round on the virtual scene interface during the virtual battle in response to the virtual battle currently proceeding to the target round.

In a case that the server places the virtual item based on the item placement preview, the terminal can display the placed virtual item on the virtual scene interface during the virtual battle in response to the virtual battle currently proceeding to the target round and the server placing the virtual item of the target round on the virtual scene interface.

This embodiment of this disclosure is described merely by using an example in which any terminal participating in the virtual battle interacts with the server. In another embodiment, a plurality of terminals participating in the virtual battle all can interact with the sever in the above manner, to achieve the virtual item placement.

In solutions provided in this embodiment of this disclosure, before the virtual battle starts, the preview of the target round of the virtual battle and the virtual item to be placed in the target round is provided, and in a case that the virtual battle proceeds to the target round, the virtual item of the target round is placed, so that the user can learn the information the about virtual item placement in the virtual battle in advance. In this way, the user can make a strategical layout on the virtual battle based on the information about the virtual item placement, which improves control of the virtual battle by the user, thereby improving user experience. In addition, before the virtual battle starts, the preview of the target round of the virtual battle and the virtual item to be placed in the target round is provided, so that the user can learn the information about the virtual item placement in the virtual battle in advance. In this way, the user can plan a game strategy for the plurality of battle rounds of the virtual battle based on the information about the virtual item placement, and make a layout in advance, thereby improving game operability, and increasing a mastering degree of the game.

In solutions provided in this embodiment of this disclosure, the server determines the item placement policy for the virtual battle, and generates the item placement preview for the plurality of object identifiers participating in the virtual battle, to provide the preview of the battle round in the virtual battle in which the virtual item is to be placed and the placed virtual item before the virtual battle starts, so that the user learns the information about the virtual item placement in the virtual battle in advance, and the same item placement preview is shared among the plurality of object identifiers in the virtual battle, so that information about the virtual item placement for the plurality of object identifiers participating in the same virtual battle is consistent. In this way, game unfairness as a result of placement of inconsistent virtual items can be eliminated, game competitiveness can be ensured, and it can be ensured that the user can plan a game strategy based on the information about the virtual item placement in the virtual battle, which improves control of the virtual battle by the user, thereby improving user experience.

Moreover, for each virtual battle, the server determines an item placement policy for the virtual battle from the plurality of item placement policies, so that the item placement policies for the plurality of virtual battles may be different. Since different random differences exist between different virtual battles, random feelings of the different virtual battles are brought to the user. Moreover, since a key item can affect a formation combination of the user, through the preview of the information about the key item placement in the virtual battle, the user can construct different formation combination policies in advance, thereby improving the user experience.

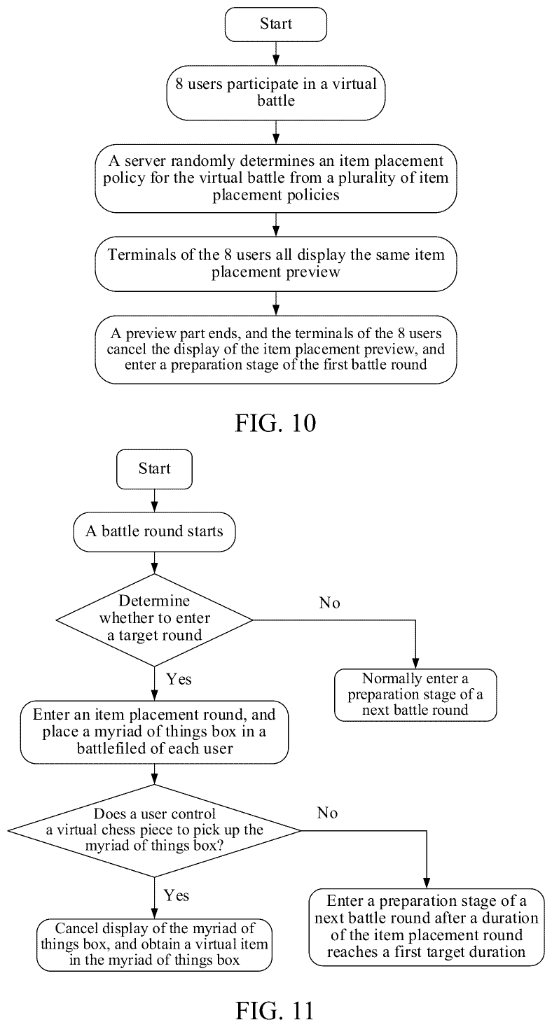

Based on the embodiments shown in FIG. 2 to FIG. 9, an embodiment of this disclosure further provides a flowchart of virtual item placement. As shown in FIG. 10 and FIG. 11, an example in which 8 users participate in a virtual battle is used as an example. A virtual item placement process includes a battle start determining stage and a virtual item placement stage.

As shown in FIG. 10, the battle start determining stage includes the following four operations:
Operation 1: A battle starts, and 8 users enter a virtual battle through terminals.
Operation 2: A server randomly determines an item placement policy for the virtual battle from a plurality of item placement policies, generates an item placement preview, and provides the item placement preview to the terminals of the users.
Operation 3: The terminals of the 8 users display the same item placement preview.
Operation 4: The preview part ends, and the terminals of the 8 users cancel the display of the item placement preview, enter a preparation stage of the first battle round, and display a plurality of item identifiers included in thumbnail information at an upper left corner of a virtual scene interface.

As shown in FIG. 11, the item placement stage includes the following five operations:
Operation 1: Determine whether the virtual battle is about to enter a target round in which a myriad of things box is to be placed when any battle round starts during the virtual battle, if no, normally enter a preparation stage of a next battle round, and if yes, perform operation 2.
Operation 2: Enter an item placement round after the target round ends, and place the myriad of things box in a battlefield of each user.
Operation 3: Determine whether the user controls a virtual chess piece to pick up the myriad of things box.
Operation 4: Cancel display of the myriad of things box in a case that the virtual chess piece is controlled to pick up the myriad of things box, obtain a virtual item in the myriad of things box, and enter the preparation stage of the next battle round when a duration of the item placement round reaches a first target duration.
Operation 5: Enter the preparation stage of the next battle round when the myriad of things box is not picked up and the duration of the item placement round reaches the first target duration.

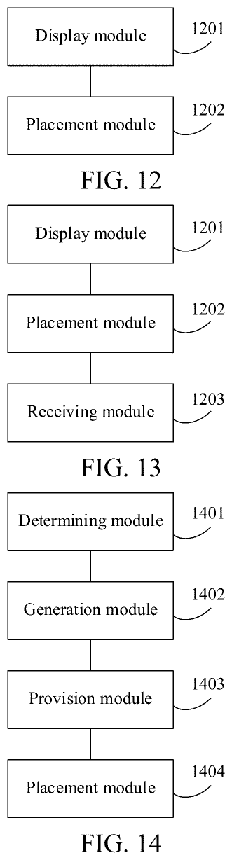

FIG. 12 is a schematic structural diagram of an item placement apparatus according to an embodiment of this disclosure. As shown in FIG. 12, the apparatus includes: a display module 1201, and a placement module 1202. The display module 1201 is configured to display a virtual scene interface of a virtual battle, the virtual battle including a plurality of battle rounds. The display module 1201 is further configured to display an item placement preview of the virtual battle on the virtual scene interface before the virtual battle starts, the item placement preview being configured for providing a preview of a target round in the virtual battle and a virtual item to be placed in the target round. The placement module 1202 is configured to place the virtual item of the target round on the virtual scene interface during the virtual battle in response to the virtual battle currently proceeding to the target round.

In a possible implementation, the display module 1201 is further configured to cancel the display of the item placement preview and display thumbnail information of the item placement preview on the virtual scene interface, in a case that the virtual battle starts.

In another possible implementation, the thumbnail information includes a plurality of item identifiers. The display module 1201 is configured to highlight an item identifier corresponding to the target round about to start as the virtual battle progresses in a case that the plurality of item identifiers are displayed on the virtual scene interface, the item identifier corresponding to the target round indicating the virtual item to be placed in the target round.

In another possible implementation, the thumbnail information includes a plurality of item identifiers. The display module 1201 is configured to display an item identifier of a placed virtual item in a placed state and display an item identifier of an unplaced virtual item in an unplaced state during the virtual battle in a case that the plurality of item identifiers are displayed on the virtual scene interface.

In another possible implementation, the placed state includes a first placed state or a second placed state. The display module 1201 is configured to: display an item identifier of a virtual item that is placed but not picked up in the first placed state; and display an item identifier of a virtual item that is placed and picked up in the second placed state.

In another possible implementation, as shown in FIG. 13, the apparatus further includes: a receiving module 1203. The receiving module 1203 is configured to receive the item placement preview transmitted by a server, the item placement preview being generated by the server based on an item placement policy for the virtual battle determined from a plurality of item placement policies before the virtual battle starts.

FIG. 14 is a schematic structural diagram of an item placement apparatus according to an embodiment of this disclosure. As shown in FIG. 14, the apparatus includes: a determining module 1401, a generation module 1402, a provision module 1403, and a placement module 1404. The determining module 1401 is configured to determine, before a virtual battle in which a plurality of object identifiers participate starts, an item placement policy for the virtual battle from a plurality of item placement policies, the virtual battle including a plurality of battle rounds. The generation module 1402 is configured to generate an item placement preview of the virtual battle based on the determined item placement policy, the item placement preview being configured for providing a preview of a target round in the virtual battle and a virtual item to be placed in the target round. The provision module 1403 is configured to provide the item placement preview on a virtual scene interface of the virtual battle, the item placement preview being displayed by terminals in which the plurality of object identifiers are logged on the virtual scene interface before the virtual battle starts. The placement module 1404 is configured to place a virtual item based on the item placement preview during the virtual battle.

In another possible implementation, the determining module 1401 is configured to determine the item placement policy for the virtual battle from the plurality of item placement policies based on historical battle information of the plurality of object identifiers.

For the item placement apparatuses provided in the above embodiments, only division of the above functional modules is described by using examples. In practical application, the functions may be completed by different functional modules as required. To be specific, an internal structure of a computer device is divided into different functional modules to complete all or some of the functions described above. In addition, the item placement apparatuses provided in the above embodiments belong to the same idea as the embodiments of the item placement methods. For a specific implementation thereof, reference is made to the method embodiments, which is not described in detail herein.

An embodiment of this disclosure further provides a computer device. The computer device includes a processor and a memory, the memory having at least one computer program stored therein, the at least one computer program being loaded and executed by the processor to implement the operations of the item placement methods in the above embodiments.

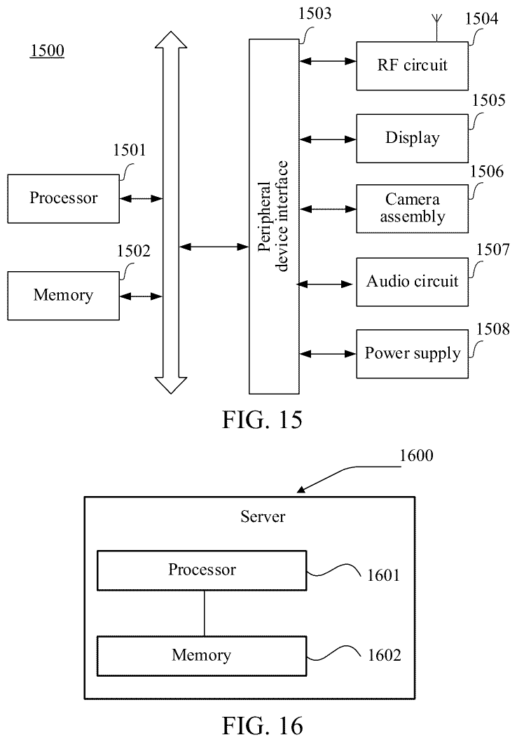

In some embodiments, the computer device is provided as a terminal. FIG. 15 is a structural block diagram of a terminal 1500 according to an exemplary embodiment of this disclosure. The terminal 1500 includes a processor 1501 and a memory 1502.

Processing circuitry, such as the processor 1501, may include one or more processing cores, for example, a 4-core processor or an 8-core processor. The processor 1501 may be implemented in at least one hardware form of a digital signal processor (DSP), a field-programmable gate array (FPGA), and a programmable logic array (PLA). The processor 1501 may alternatively include a main processor and a coprocessor. The main processor is a processor configured to process data in an awaken state, which is also referred to as a CPU. The coprocessor is a low power processor configured to process data in a standby state. In some embodiments, the processor 1501 may have a graphics processing unit (GPU) integrated therein. The GPU is configured to render and draw content that needs to be displayed on a display. In some embodiments, the processor 1501 may further include an AI processor. The AI processor is configured to perform computing operations related to machine learning.

The memory 1502 may include one or more computer-readable storage media. The computer-readable storage media may be non-transient. The memory 1502 may further include a high-speed random access memory and a non-volatile memory, for example, one or more disk storage devices or flash storage devices. In some embodiments, the non-transient computer-readable storage media in the memory 1502 are configured to store at least one computer program. The at least one computer program is configured to be executed by the processor 1501, to implement the item placement methods provided in the method embodiments of this disclosure.

In some embodiments, the terminal 1500 further includes a peripheral device interface 1503 and at least one peripheral device. The processor 1501, the memory 1502, and the peripheral device interface 1503 may be connected through a bus or a signal line. Each peripheral device may be connected to the peripheral device interface 1503 through a bus, a signal line, or a circuit board. Specifically, the peripheral device includes at least one of a radio frequency (RF) circuit 1504, a display 1505, a camera assembly 1506, an audio circuit 1507, and a power supply 1508.

The peripheral device interface 1503 may be configured to connect the at least one peripheral device related to input/output (I/O) to the processor 1501 and the memory 1502. In some embodiments, the processor 1501, the memory 1502, and the peripheral device interface 1503 are integrated on the same chip or circuit board. In some other embodiments, any one or two of the processor 1501, the memory 1502, and the peripheral device interface 1503 may be implemented on an independent chip or circuit board, which is not limited in this embodiment. The RF circuit 1504 is configured to receive and transmit an RF signal, which is also referred to as an electromagnetic signal. The RF circuit 1504 communicates with a communication network and another communication device through the electromagnetic signal. The RF circuit 1504 converts an electric signal into an electromagnetic signal for transmission, or converts a received electromagnetic signal into an electric signal. In some embodiments, the RF circuit 1504 includes an antenna system, an RF transceiver, one or more amplifiers, a tuner, an oscillator, a DSP, a codec chipset, a user identity module card, and the like. The RF circuit 1504 may communicate with the another terminal through at least one wireless communication protocol. The wireless communication protocol includes but is not limited to the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF circuit 1504 may further include a near field communication (NFC)-related circuit, which is not limited in this disclosure.

The display 1505 is configured to display a user interface (UI). The UI may include graphics, texts, icons, videos, and any combination thereof. When the display 1505 is a touch display, the display 1505 further has a capability of collecting a touch signal on or above a surface of the display 1505. The touch signal may be inputted into the processor 1501 as a control signal for processing. In this case, the display 1505 may be further configured to provide a virtual button and/or a virtual keyboard, which is also referred to as a soft button and/or a soft keyboard. In some embodiments, one display 1505 may be arranged on a front panel of the terminal 1500. In some other embodiments, at least two displays 1505 may be respectively arranged on different surfaces of the terminal 1500 or folded. In some other embodiments, the display 1505 may be a flexible display arranged on a curved surface or a folded surface of the terminal 1500. The display 1505 may alternatively be arranged as a non-rectangular irregular pattern, i.e., a special-shaped screen. The display 1505 may be manufactured by using a material such as a liquid crystal display (LCD) or an organic light-emitting diode (OLED).

The camera assembly 1506 is configured to capture an image or a video. In some embodiments, the camera assembly 1506 includes a front camera and a rear camera. The front camera is arranged on the front panel of the terminal, and the rear camera is arranged on a back of the terminal. In some embodiments, at least two rear cameras are arranged, which are respectively any one of a main camera, a depth-of-field camera, and a wide-angle camera, so as to achieve a background blurring function through fusion of the main camera and the depth-of-field camera, achieve a panoramic photographing function and a virtual reality (VR) photographing function through fusion of the main camera and the wide-angle camera, or achieve other fusion photographing functions. In some embodiments, the camera assembly 1506 may further include a flashlight. The flashlight may be a single-color-temperature flashlight or a dual-color-temperature flashlight. The dual-color-temperature flashlight is a combination of a warm flashlight and a cold flashlight, and may be configured for light compensation at different color temperatures.

The audio circuit 1507 may include a microphone and a speaker. The microphone is configured to collect a sound wave of a user and an environment, and convert the sound wave into an electrical signal and input the electrical signal to the processor 1501 for processing, or input the electrical signal to the RF circuit 1504 to achieve voice communication. For stereo collection or noise reduction, a plurality of microphones may be respectively arranged at different parts of the terminal 1500. The microphone may alternatively be an array microphone or an omnidirectional collection microphone. The speaker is configured to convert an electrical signal from the processor 1501 or the RF circuit 1504 into a sound wave. The speaker may be a conventional film speaker, or may be a piezoelectric ceramic speaker. When the speaker is the piezoelectric ceramic speaker, the speaker can not only convert an electric signal into a sound wave audible to human beings, but also convert the electric signal into a sound wave inaudible to human beings for ranging and the like. In some embodiments, the audio circuit 1507 may further include a headphone jack.

The power supply 1508 is configured to supply power to components in the terminal 1500. The power supply 1508 may be an alternating current power supply, a direct current power supply, a disposable battery, or a rechargeable battery. When the power supply 1508 includes a rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may be further configured to support a fast charging technology.

A person skilled in the art may understand that the structure shown in FIG. 15 does not constitute a limitation on the terminal 1500, and the terminal may include more or fewer components than those shown in the figure, or some merged components, or different component arrangements.

In some embodiments, the computer device is provided as a server. FIG. 16 is a schematic structural diagram of a server according to an embodiment of this disclosure. A server 1600 may vary considerably depending on configuration or performance, and may include one or more central processing units (CPUs) 1601 and one or more memories 1602. Each memory 1602 has at least one computer program stored therein. The at least one computer program is loaded and executed by the processor 1601, to implement the methods provided in the above method embodiments. Certainly, the server may further have components such as a wired or wireless network interface, a keyboard, and an I/O interface for input and output. The server may further include another component for achieving a device function. Details are not described herein.

An embodiment of this disclosure further provides a computer-readable storage medium, such as a non-transitory computer-readable storage medium, having at least one computer program stored therein, the at least one computer program being loaded and executed by a processor, to implement the operations of the item placement methods provided in the above embodiments.

An embodiment of this disclosure further provides a computer program product, including a computer program, the computer program, when executed by a processor, implementing the operations of the item placement methods provided in the above embodiments.

A person of ordinary skill in the art may understand that all or some of the operations implementing the above embodiments may be implemented by hardware, or may be implemented by instructing relevant hardware through a program. The program may be stored in a computer-readable storage medium. The storage medium may be a read-only memory, a disk, an optical disc, or the like.

The above descriptions are merely examples of the embodiments of this disclosure, and are not intended to limit the embodiments of this disclosure. Any modification, equivalent replacement, improvement, or the like made within the spirit and principle of the embodiments of this disclosure falls within the protection scope of this disclosure.

What is claimed is:

1. A method for item placement in a virtual battle, the method comprising:
displaying, by processing circuitry, an item placement preview of the virtual battle before the virtual battle starts, the item placement preview being configured to provide a preview of a target round of a plurality of battle rounds in the virtual battle and a virtual item to be placed in the target round;
displaying a virtual scene of the virtual battle when the virtual battle starts; and
adding the virtual item of the target round to the displayed virtual scene during the virtual battle when the virtual battle proceeds to the target round.

2. The method according to claim 1, further comprising:
when the virtual battle starts,
canceling the display of the item placement preview; and
displaying thumbnail information of the virtual item in the item placement preview with the virtual scene.

3. The method according to claim 2, wherein the thumbnail information includes a plurality of item identifiers of a plurality of target rounds, and the displaying the thumbnail information comprises:
highlighting an item identifier of the plurality of item identifiers corresponding to the target round when the target round is a next target round of the plurality of target round as the virtual battle progresses, the item identifier corresponding to the target round indicating the virtual item to be placed in the target round.

4. The method according to claim 2, wherein the thumbnail information includes a plurality of item identifiers, and the displaying the thumbnail information comprises:
displaying a first item identifier in the plurality of item identifiers of a placed virtual item in a placed state and displaying a second item identifier in the plurality of identifiers of an unplaced virtual item in an unplaced state during the virtual battle.

5. The method according to claim 4, wherein the placed state is one of first placed state and a second placed state, and the displaying the first item identifier comprises:
displaying the first item identifier of the virtual item in the first placed state when the virtual item is placed and not picked up; and
displaying the first item identifier of the virtual item in the second placed state when the virtual item is placed and picked up.

6. The method according to claim 1, further comprising:
receiving the item placement preview transmitted by a server, the item placement preview being generated by the server based on an item placement policy for the virtual battle determined from a plurality of item placement policies before the virtual battle starts.

7. The method according to claim 1, wherein the item placement preview indicates a plurality of items to be placed in the virtual scene and which of the plurality of battle rounds is associated with each of the plurality of items.

8. The method according to claim 1, wherein
the item placement preview indicates a type of the virtual item to be placed in the target round; and
the virtual item is selected from a plurality of candidate virtual items associated with the type of the virtual item.

9. A method for item placement in a virtual battle, the method comprising:
determining, before the virtual battle starts, an item placement policy for the virtual battle from a plurality of item placement policies, the virtual battle including a plurality of battle rounds;
generating, by processing circuitry, an item placement preview of the virtual battle based on the determined item placement policy, the item placement preview being configured to provide a preview of a target round of the plurality of battle rounds in the virtual battle and a virtual item to be placed in the target round;
providing the item placement preview to a plurality of terminals that is associated with a plurality of players of the virtual battle, the item placement preview being displayed by the plurality of terminals before the virtual battle starts; and
adding the virtual item indicated by the item placement preview in a virtual scene of the virtual battle during the virtual battle.

10. The method according to claim 9, wherein the determining the item placement policy comprises:
determining the item placement policy for the virtual battle from the plurality of item placement policies based on historical battle information of the plurality of players.

11. The method according to claim 8, wherein the item placement preview indicates a plurality of items to be placed in the virtual scene and which of the plurality of battle rounds is associated with each of the plurality of items.

12. The method according to claim 8, wherein
the item placement preview indicates a type of the virtual item to be placed in the target round; and
the virtual item is selected from a plurality of candidate virtual items associated with the type of the virtual item.

13. An information processing apparatus, comprising:
processing circuitry configured to:
display an item placement preview of a virtual battle before the virtual battle starts, the item placement preview being configured to provide a preview of a target round of a plurality of battle rounds in the virtual battle and a virtual item to be placed in the target round;
display a virtual scene of the virtual battle when the virtual battle starts; and
add the virtual item of the target round to the displayed virtual scene during the virtual battle when the virtual battle proceeds to the target round.

14. The information processing apparatus according to claim 13, wherein the processing circuitry is configured to:
when the virtual battle starts,
cancel the display of the item placement preview; and
display thumbnail information of the virtual item in the item placement preview with the virtual scene.

15. The information processing apparatus according to claim 14, wherein the thumbnail information includes a plurality of item identifiers of a plurality of target rounds, and the processing circuitry is configured to:
highlight an item identifier of the plurality of item identifiers corresponding to the target round when the target round is a next target round of the plurality of target round as the virtual battle progresses, the item identifier corresponding to the target round indicating the virtual item to be placed in the target round.

16. The information processing apparatus according to claim 14, wherein the thumbnail information includes a plurality of item identifiers, and the processing circuitry is configured to:
display a first item identifier in the plurality of item identifiers of a placed virtual item in a placed state and display a second item identifier in the plurality of identifiers of an unplaced virtual item in an unplaced state during the virtual battle.

17. The information processing apparatus according to claim 16, wherein the placed state is one of a first placed state and a second placed state, and the processing circuitry is configured to:
display the first item identifier of the virtual item in the first placed state when the virtual item is placed and not picked up; and
display the first item identifier of the virtual item in the second placed state when the virtual item is placed and picked up.

18. The information processing apparatus according to claim 13, wherein the processing circuitry is configured to:
receive the item placement preview transmitted by a server, the item placement preview being generated by the server based on an item placement policy for the virtual battle determined from a plurality of item placement policies before the virtual battle starts.

19. A non-transitory computer-readable storage medium, storing instructions which when executed by a processor cause the processor to perform the method according to claim 1.

20. A non-transitory computer-readable storage medium, storing instructions which when executed by a processor cause the processor to perform the method according to claim 9.
